(19) United States
(12) Patent Application Publication
(10) Pub. No.: US 2026/0093545 A1
(43) Pub. Date: Apr. 2, 2026

(54) TASK PLANNING USING MACHINE LEARNING MODELS

(71) Applicant: GDM Holding LLC, Mountain View, CA (US)

(72) Inventors: Xinran Zhao, Pittsburgh, PA (US); Hanie Sedghi, Mountain View, CA (US); Bernd Bohnet, Amsterdam (NL); Azade Nova, San Jose, CA (US)

(21) Appl. No.: 19/345,015

(22) Filed: Sep. 30, 2025

Related U.S. Application Data
(60) Provisional application No. 63/702,112, filed on Oct. 1, 2024.

(51) Int. Cl. G06F 9/50

(52) U.S. Cl. CPC G06F 9/5027

(57) ABSTRACT

Methods, systems, and apparatus, including computer programs encoded on computer storage media, for generating a plan for an input task. The method involves receiving a query for the input task and obtaining candidate task-plan examples. An initial plan, comprising an initial action sequence, is obtained for the input task. For each candidate example, an action sequence similarity score is computed, measuring similarity between the initial action sequence and the action sequence in the candidate example. A set of task-plan examples is selected from the candidates using these similarity scores. Finally, a generative machine learning model processes the query and prompt inputs generated from the selected set of examples to generate an output plan. This approach improves plan generation by selecting relevant examples based on procedural similarity rather than superficial task description similarity, enhancing the quality and accuracy of the output plan.

### CROSS-REFERENCE TO RELATED APPLICATION

This application claims priority to U.S. Provisional Patent Application No. 63/702,112, filed on October 1, 2024, the disclosure of which is hereby incorporated by reference in its entirety.

### BACKGROUND

This specification relates to generating a plan for a task using a machine learning model, such as a neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

A generative machine learning model is a machine learning model that can generate new data, such as text, images, audio, or videos, or music, in response to input queries.

### SUMMARY

This specification describes a system implemented as computer programs on one or more computers in one or more locations that generates a response to a query relating to an environment (e.g., a real-world environment). In particular, the system receives a query requesting a plan for a given task, and uses a generative machine learning model to process the query with one or more prompts that describe example tasks and their corresponding plans to generate a plan that specifies a sequence of actions for achieving the task.

In one aspect, this specification describes a method for generating a response to a query. The method is implemented by a system including one or more computers. The method comprises: receiving a query comprising a request to generate a plan for an input task; obtaining candidate example data defining a plurality of candidate task-plan examples, wherein each candidate task-plan example comprises (i) a respective example task and (ii) a respective example plan for achieving the respective example task; obtaining data defining an initial plan for the input task, wherein the initial plan comprises an initial action sequence that includes a sequence of a plurality of actions; computing, for each of the plurality of candidate task-plan examples, a respective action sequence similarity score measuring a similarity between (i) the initial action sequence and (ii) a respective action sequence included in the respective example plan in the candidate task-plan examples; selecting, using the action sequence similarity scores, a set of task-plan examples from the plurality of candidate task-plan examples; and processing, using a generative machine learning model, (i) the query and (ii) one or more prompt inputs generated using the selected set of task-plan examples, to generate an output plan.

In some implementations, obtaining the data defining the initial plan for the input task comprises: selecting an initial set of task-plan examples from the candidate task-plan examples; and processing, using the generative machine learning model, (i) the query and (ii) one or more prompt inputs generated using the selected initial set of task-plan examples to generate the initial plan.

In some implementations, the initial set of task-plan examples is randomly selected from the candidate task-plan examples.

In some implementations, the method further comprises: determining a validity of the initial plan for the input task; and in response to determining that the initial plan is invalid, generating a revised initial plan.

In some implementations, determining the validity of the initial plan comprises: determining whether the initial action sequence of the initial plan satisfies one or more of: a first condition that each action in the initial action sequence complies with a first predefined set of rules; a second condition that sequential dependencies between the actions in the initial action sequence comply with a second predetermined set of rules; or a third condition that the initial action sequence achieves one or more goals associated with the input task according to a third predefined set of rules; and determining that the initial plan is valid in response to determining that the initial action sequence satisfies the one or more of the first condition, the second condition, or the third condition.

In some implementations, generating the revised initial plan comprises: selecting a new initial set of task-plan examples from the candidate task-plan examples; and generating the revised initial plan for the input task using the new initial set of task-plan examples from the candidate task-plan examples.

In some implementations, obtaining the data defining the initial plan for the input task comprises selecting the initial set of task-plan examples at each of a plurality of iterations, wherein selecting the initial set of task-plan examples comprises, at each iteration after the first iteration: computing updated action sequence similarity scores between (i) an action sequence included in the output plan generated by the generative machine learning model in a preceding iteration and (ii) the respective action sequences included the respective example plans in the candidate task-plan examples; selecting, using the updated action sequence similarity scores, an updated set of task-plan examples from the plurality of candidate task-plan examples; and processing, using the generative machine learning model, (i) the query and (ii) one or more prompt inputs generated using the updated set of task-plan examples, to generate the output plan for the iteration.

In some implementations, selecting, using the action sequence similarity scores, the set of task-plan examples from the plurality of candidate task-plan examples comprises: selecting a first subset of candidate task-plan examples with respective action sequence similarity scores above a first threshold score; and including the first subset of candidate task-plan examples in the selected set of task-plan examples.

In some implementations, determining the first threshold score comprises: obtaining distribution data characterizing a distribution of the respective action sequence similarity scores of the set of candidate task-plan examples; and determining the first threshold score based on the distribution data.

In some implementations, determining the first threshold score comprises: obtaining a mean value and a standard deviation value of the distribution; and determining the first threshold score based on the mean value and the standard deviation value.

In some implementations, selecting, using the action sequence similarity scores, the set of task-plan examples from the plurality of candidate task-plan examples further comprises: selecting a second subset of candidate task-plan examples with respective action sequence similarity scores between the first threshold score and a second threshold score, wherein the second threshold score is below the first threshold score; selecting a third subset of candidate task-plan examples from the second subset of candidate task-plan examples; and including the third subset of candidate task-plan examples in the selected set of task-plan examples.

In some implementations, selecting the third subset of candidate task-plan examples comprises: performing a clustering operation on the second subset of candidate task-plan examples to group the candidate task-plan examples into clusters based on action sequence similarity scores computed for action sequences of each pair of the candidate task-plan examples in the second subset; and selecting one or more candidate task-plan examples from each cluster.

In some implementations, selecting one or more candidate task-plan examples from each cluster comprises: selecting no more than a threshold number of candidate task-plan examples from each cluster.

In some implementations, computing the respective action sequence similarity score between (i) the initial action sequence and (ii) the respective action sequence corresponding to the respective example plan comprises: identifying a longest common subsequence of actions between the initial action sequence and the respective action sequence; and computing the action sequence similarity score based on a ratio of the length of the longest common subsequence relative to the lengths of the initial action sequence and the respective action sequences.

In some implementations, the generative machine learning model comprises a neural network comprising one or more attention layers.

In some implementations, parameters of the generative machine learning model remain unchanged during generating the plan for the input task.

In some implementations, the input task specifies a task in a real-world environment, and the output plan specifies actions or routes to be taken in the real-world environment.

In some implementations, the input task specifies a physical task to be completed by one or more robotic agents in the real-world environment, and the output plan comprises a sequence of actions for the robotic agents to complete the physical task.

In some implementations, the input task specifies navigating a vehicle to a destination in the real-world environment, and the output plan comprises a sequence of navigational instructions for the vehicle to reach the destination.

In some implementations, the input task specifies diagnosing a fault of a system operating in the real-world environment given observations of the system, and the output plan specifies a sequence of measurements to be made for diagnosing the fault.

In some implementations, the method further comprises: providing the plan for execution. In some cases, providing the plan for execution comprises: providing the plan to a computer-implemented control system to cause the computer-implemented control system to generate one or more control signals for executing the plan.

In some implementations, computing the respective action sequence similarity score for each of the plurality of candidate task-plan examples comprises: computing two or more of the similarity scores in parallel.

In some implementations, wherein the query comprises a text sequence.

In some implementations, the query comprises one or more of: an image, a video, an audio, or sensor data.

In another aspect, this specification describes a method for training a generative machine learning model. The method is implemented by a system including one or more computers. The method comprises: obtaining one or more training examples, each training example comprising data specifying (i) an input task and (ii) a corresponding target plan that includes a target action sequence; for each training example, generating an output for the input task using the generative machine learning model, and computing an action sequence similarity score that measures a similarity between (i) an output action sequence included in the generated output plan and (ii) the target action sequence included in the target plan; and updating values of parameters of the generative machine learning model using at least the action sequence similarity score computed for the one or more training examples.

In another aspect, this specification describes a system including one or more computers and one or more storage devices storing instructions that when executed by the one or more computers cause the one or more computers to perform the operations of the method described above.

In another aspect, this specification describes one or more computer storage media storing instructions that when executed by one or more computers cause the one or more computers to perform the operations of the method described above.

The described subject matter can be implemented in particular implementations so as to realize one or more of the following advantages.

A generative machine learning model, e.g., an LLM, can be pre-trained to generate an output in response to a wide range of queries and prompts. The language model can be adapted to generating responses to a particular category of queries using contextual learning (also referred to as in-context learning), i.e., by conditioning the model using prompt inputs that include examples of queries and corresponding responses. Contextual learning offers several advantages over fine-tuning the model. Contextual learning doesn’t require updating the model’s weights through training, e.g., by using backpropagation and gradient descent. This makes contextual learning more efficient, flexible, and capable of responding to dynamic inputs across diverse domains.

The effectiveness of contextual learning depends on the selection of prompt examples. These examples, which typically includes of a sample task and its corresponding correct plan, can be included in the model's prompt to provide a template for the desired output format and logical structure. However, selecting relevant examples can be challenging, especially for generating plans. As plans often involve a series of interdependent actions, a small change in the initial conditions or goals of a task can necessitate a completely different sequence of actions. Therefore, relying solely on semantic similarity between task descriptions when selecting examples for contextual learning can be misleading, as it might not capture the logic in the required actions. Using non-optimal examples can lead the model to generate plans that are overly generic, illogical, or incorrect, resulting in poor performance and increased retries.

Implementations of the described system can address the above and other problems by optimally selecting task-plan examples for prompting the generative model. In particular, the task-plan examples are selected using an initial plan that is relevant to the input task, and action sequence similarity is used to measure how alike the sequence of actions in the initial plan is to the action sequences in the candidate examples. Examples with high action sequence similarity are then selected to prompt the language model. This approach improves the performance of the language model by focusing on the sequence of actions needed to achieve the goal - rather than the surface-level similarity of the task descriptions. This technique provides several advantages, including higher-quality output plans, fewer required examples, and a reduction in retries, which in turn saves computational resources. Additionally, the similarity scores can be computed in parallel, further speeding up the selection process by leveraging modern computing architectures. For example, the system 100 can distribute the computation of similarity scores across multiple processor cores, graphics processing units (GPUs), or tensor processing units (TPUs), allowing multiple pairwise sequence comparisons to be evaluated simultaneously. This parallelization can significantly reduce latency in the example selection pipeline, enabling the system to handle large candidate pools and complex action sequences in real time or near real time.

The parallelization allows the system to handle large pools of candidate examples efficiently.

In certain implementations, the language model generates the initial plan based on the input task. For example, the initial plan can be generated by prompting the language model using randomly selected initial examples. In another example, the initial plan can be generated by prompting the language model using examples selected based on problem similarity, where examples with task descriptions similar to the input task are chosen. In another example, the initial plan can be generated by prompting the language model using chain-of-thought prompting, where the model is guided by one or more prompts to generate a series of reasoning steps before producing the final plan. Generating the initial plan removes the need for a pre-defined or “oracle” plan. As a result, the system becomes more adaptable to new or unfamiliar tasks without the need for pre-defined plans for every new task. Furthermore, in some cases, the system can optionally employ an iterative process, where the model-generated plan from one iteration is used as the initial plan to refine the selection of examples for the next iteration. The iterative refinement can lead to progressively better plans as the model learns from its own outputs.

In certain implementations, a dynamic clustering process is performed to select a subset of task-plan examples from the pool of candidate examples. By grouping similar task-plan examples into clusters based on their action sequence similarity scores and selecting task-plan examples from each cluster, the system can select examples that cover a more diverse range of solutions without being redundant. That is, this approach improves the diversity of the selected examples, which prevents the model from being biased towards a narrow subset of solutions. This leads to more generalized and robust output plans and reduces the likelihood of overfitting to a particular type of task example. Additionally, clustering can help reduce the number of representative examples needed for prompting, further optimizing computational efficiency.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning system for generating a response to a query.

FIG. 2 illustrates an example two-stage process for selecting task-plan examples based on action sequence similarity and dynamic clustering.

FIG. 3 is a flow diagram of an example process for generating a plan for an input task using a generative machine learning model.

FIG. 4A and FIG. 4B show a set of charts comparing the performance of the described example selection techniques with baseline techniques.

Like reference numbers and designations in the various drawings indicate like elements.

### DETAILED DESCRIPTION

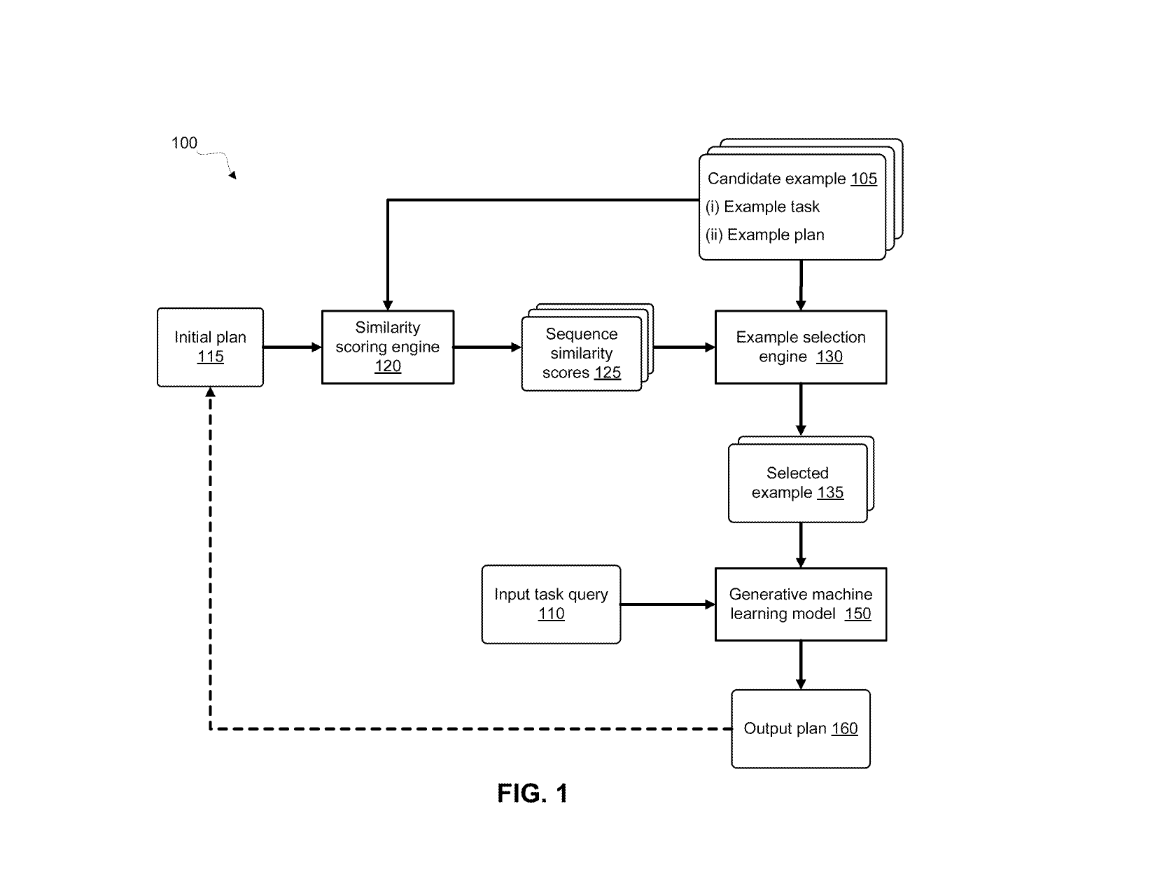

FIG. 1 shows an example machine learning system 100 for generating a response to a query using a generative machine learning model 150. In particular, the system 100 generates an output plan 160 in response to an input task query 110 that includes a request to generate a plan for an input task. The machine learning system 100 is an example of a system implemented as computer programs on one or more computers in one or more locations, in which the systems, components, and techniques described below can be implemented.

In this specification, a plan can refer to a structured strategy or solution to achieve a particular goal in response to a task, which includes an action sequence that includes a sequence of multiple actions. In some cases, a plan further includes context information in addition to the action sequence, such as object affordance information, which specifies the objects involved in each action and how they can be manipulated.

In this specification, an action sequence can refer to an ordered list of actions that, when executed, transform an initial state of a system into a desired goal state. Each action represents a discrete operation that can be carried out by an agent or a computing system, and the semantics of the action depend on the domain in which the plan is applied. In general, the execution of an action causes a change in the environment or in the state of the system being controlled.

An “action” used herein can take many forms depending on the implementation. For example, an action may be a computer control action, such as invoking an application programming interface (API), executing a software function, or issuing a database query. In other implementations, an action may be a robot control action, such as commanding a robotic arm to grasp an object, move to a target position, or release the object at a designated location. Actions can also include facility or machine control actions, such as activating or deactivating an assembly line component, adjusting a valve in a chemical processing plant, or triggering a maintenance routine in an automated facility. In each case, the action specifies at least one operator and, optionally, one or more parameters that define the context or data associated with the operation.

In some implementations, an action can also represent a call to an external computational service. For example, an action may identify a software tool or service along with a set of parameters for invoking the tool. Examples include a call to a translation API with parameters specifying source and target languages, a call to a numerical solver with parameters defining an equation to be solved, or a call to an image recognition service with parameters identifying an image input.

An action sequence provides a structured representation of task execution logic that can be domain-independent. It can encompass low-level control commands (e.g., motor instructions to a robot), mid-level operations (e.g., invoking a machine controller in a facility), or high-level computational tasks (e.g., querying a database or calling a machine learning inference API).

The generative machine learning model 150 can be a pre-trained language model, e.g., a large language model (LLM) configured to receive the query as an input text sequence, and output the plan as an output text sequence. As a particular example, the language model can include an auto-regressive Transformer-based neural network that includes (i) a sequence of attention blocks that each applies a self-attention operation and (ii) an output subnetwork that processes an output of the last attention block to generate a score distribution for the next token in the output sequence. In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J.W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A.Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d’Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020 In some cases, the generative machine learning model 150 can include an architecture in the Gemini family. In some cases, the generative machine learning model 150 can include an architecture in the Gemma family.

In some cases, the generative machine learning model 150 can receive a query that includes multi-modal data. In general, multi-modal data is a combination of two or more different types of data, e.g., two or more of audio data, image data, text data, or graph data. As one example the multi-modal data may include audio-visual data, including a combination of pixels of an image or of video and audio data representing values of a digitized audio waveform. As another example the multi-modal data may include a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space..

The output plan 160 generated by the language model can be used in a variety of ways. For example, the output plan can be a travel itinerary, where the sequence of actions specifies the order of destination to visit, flight schedules, and durations of stay at each destination. In other examples, the plan can be used in task scheduling, where the language model generates a sequence of subtasks to be completed by a worker or a team in an optimized order based on constraints such as deadlines and resource availability.

In another example, the task can be a coding task, and the output plan can include a sequence of code statements generated by the language model to solve a specific coding problem. The action sequence in this case can represent the sequence code statements in the order in which they should be executed to achieve the desired outcome.

In another example, the task can be a web traversal task, and the output plan can include a sequence of actions for navigating through web pages. In certain applications, an agent collects specific information or accomplishes tasks on one or more websites. The generative machine learning model can generate a plan specifying the web pages to visit, the data to extract from each page, and the actions to take, such as filling out forms, clicking buttons, or downloading files. By specifying these steps in the correct sequence, the agent can efficiently browse the web, extract relevant information, and perform tasks without human intervention.

In another example, the task can be a mathematical reasoning task, and the output plan can include a series of mathematical operations or steps required to solve a complex equation or prove a theorem. The action sequence can represent the logical order in which these operations should be performed to arrive at the correct solution or proof.

In some implementations, the output plan includes a sequence of actions, where one or more of the actions are calls to external software tools. Each call action in the sequence can identify the specific tool to be invoked, for instance via an Application Programming Interface (API), and can include the parameters required for the tool's operation. The system 100 can execute the plan by dispatching calls to the corresponding external software and providing the specified parameters.

In some cases, the input task is a task in a real-world environment, and the output plan specifies actions or routes to be taken in the real-world environment. The system can provide the output plan generated by the language model for execution. For example, the system can transmit the generated plan to a computer-implemented control system to cause the control system to generate control signals for executing the plan.

In one example, the input task specifies a physical task to be completed by one or more robotic agents in the real-world environment. The output plan includes a sequence of actions for the robotic agents to complete the physical task. The system can provide the output plan to a robot control system that generates robot control signals based on the output plan.

In another example, the input task specifies navigating a vehicle to a destination in the real-world environment. The output plan includes a sequence of navigational instructions for the vehicle to reach the destination. The system can provide the output plan to an autonomous driving system that generates vehicle control signals based on the output plan.

In yet another example, the input task specifies diagnosing a fault of a system (e.g., a mechanical system, an electrical system, or an electronic system) operating in the real-world environment given observations of the system. The output plan specifies a sequence of measurements to be made for diagnosing the fault. The system can provide the output plan to a control that controls one or more sensors to make the measurements according to the output plan. In some cases, the input task can be a task for an agent to perform in a simulated environment. For example, the task can be a simulated robotic task in a simulation, the output plan can include a sequence of actions such as moving to different locations, interacting with objects, or achieving specific goals in the simulated environment. In another example, the task can be a task in a computer game, and the output plan can include a sequence of actions for a player or an agent to execute, such as moving through levels, solving puzzles, or completing quests. The plan can include strategies for optimizing gameplay, resource management, and achieving high scores based on predefined objectives and constraints within the game environment.

In operation, the system 100 receives a query 110 that includes a request to generate a plan for an input task. The query 110 can include a text sequence, or it may include one or more of an image, a video, an audio, or sensor data. For example, a query 110 can be a natural language text request, such as “plan a 14-day trip to visit Florence, Barcelona, and Helsinki, with 6 days in Florence” for a travel planning application.

In another example, for a robotic control task, the query 110 can include structured text, e.g., in a Planning Domain Definition Language (PDDL) format, specifying a goal such as to move a robotic arm from an initial state where it holds no object to a goal state where it has grasped a specified tool from a storage rack and placed the tool onto a designated work surface.

In some implementations, the query 110 can be multi-modal and include one or more of an image, a video, an audio, or sensor data. For instance, a query 110 can combine an image of a disordered shelf with the text “organize the items on this shelf,” for which the system 100 is to generate a plan for a robotic agent.

In a further example, the query 110 can include sensor data from a vehicle, such as GPS coordinates and obstacle detection information, along with a text request like “navigate to the destination while avoiding congested routes.”

The system 100 also obtains candidate example data defining a plurality of candidate task-plan examples 105. Each candidate task-plan example 105 includes a respective example task and a corresponding example plan for achieving that task.

These task-plan examples 105 can function as demonstrations or exemplars to guide the generative machine learning model 150, e.g., through in-context prompting. By providing the model 150 with high-quality, relevant examples of how specific tasks are solved, the system 100 can facilitate the generation of a more accurate and logically sound output plan 160.

The system 100 can obtain the candidate task-plan examples 105 from various sources. In some implementations, the examples can be retrieved from a pre-populated database or a dedicated exemplar candidate pool, which can be curated from historical data, expert-designed problem-solution pairs, or outputs from automated environment exploration. For example, in a web navigation application, the candidate examples can include records of successful user trajectories for completing specific online tasks. In other implementations, the system 100 can dynamically generate or synthesize candidate examples, for instance, by using a separate generative model to create new task-plan pairs or by augmenting existing examples. In some cases, candidate examples can be provided directly by a user of the system, for instance, by uploading a history of their own previously executed successful plans.

The quality and relevance of the provided task-plan examples can substantially influence the effectiveness of the generative model's plan generation process for a particular request. A generative model’s ability to produce a coherent plan is contingent upon the exemplars presented in its context window. If the examples are irrelevant or misleading, the model may generate plans that are suboptimal, illogical, or entirely incorrect. This is particularly critical for planning tasks where the sequence of actions is highly dependent on initial conditions and goals. Furthermore, because plans can be lengthy due to their long sequences of actions, the limited size of this context window restricts the number of examples that can be included in a single prompt. In such cases, simply including as many examples as possible is not effective; instead, it becomes crucial to select the most relevant and informative exemplars. Seemingly similar task descriptions can necessitate drastically different action sequences. For example, two tasks might involve rearranging a stack of blocks, but a minor difference in the initial or goal state (e.g., whether a target block is at the top or bottom of a tall stack) can fundamentally change the complexity and the required sequence of operations. Relying on superficial similarity between task descriptions, such as token overlap or semantic embedding similarity, can be a suboptimal strategy, as it may fail to capture the underlying logic of the required plan. This can lead to the selection of “false positive” exemplars that misguide the model, resulting in poor planning performance and increased computational cost due to retries.

Therefore, a robust selection strategy is beneficial to identify exemplars that are truly relevant to the input task, not just at the surface level of the task description, but at the structural level of the required solution or plan. The system 100 implements such a strategy by focusing on the similarity of the action sequences themselves. The selection process can be summarized as a multi-stage approach. First, an initial plan is obtained for the input task, which serves as a reference. Second, this initial plan’s action sequence is compared against the action sequences of candidate task-plan examples to compute action sequence similarity scores. This step prioritizes examples that share a similar procedural logic or “core strategy” with the initial reference plan. Third, based on these scores, a refined set of high-relevance examples is selected. This selection may also incorporate a dynamic clustering step to ensure the chosen exemplars are not only relevant but also diverse, covering different but related solution patterns and preventing redundancy. This strategy ensures that the examples provided to the generative model 150 are highly pertinent to the logical structure of the required output plan, thereby improving the model’s planning capability.

The system 100 obtains data defining the initial plan 115 for the input task. The initial plan 115 includes an initial action sequence that includes a sequence of a plurality of actions. In some implementations, the system 100 can generate the initial plan 115 by first selecting an initial set of task-plan examples from the candidate task-plan examples 105. For example, the initial set of task-plan examples can be randomly selected. The system 100 can then process, using the generative machine learning model 150, the query 110 and one or more prompt inputs generated using the selected initial set of task-plan examples to generate the initial plan 115.

In certain implementations, the system 100 can be configured to determine the validity of the initial plan 115 for the input task. The system 100 can determine that the initial plan 115 is valid in response to its action sequence satisfying one or more of conditions. For example, a first condition can be that each action in the initial action sequence is valid and executable at each step. The system can check this by verifying that all necessary preconditions for an action are met in the environment’s state before that action is performed. For instance, an action may be deemed invalid if it results in undefined behavior or a failed precondition, such as a robotic agent attempting to pick up a new object when its hand is already full. In another example, a second condition can be that the sequential dependencies between the actions are logically sound. This can be checked, e.g., by confirming that the state changes caused by each action correctly establish the necessary preconditions for the subsequent action in the sequence. In another example, a third condition is that the complete action sequence, when fully executed, achieves the one or more goals associated with the input task. The system can confirm this by comparing the final state of the environment after the last action to the desired goal state described in the task.

If the system 100 determines that the initial plan is invalid, it can generate a revised initial plan, for instance, by selecting a new initial set of task-plan examples and using this new set to generate the revised plan.

The initial plan 115, along with the candidate task-plan examples 105, is provided to a similarity scoring engine 120. The similarity scoring engine 120 is configured to compute, for each of the plurality of candidate task-plan examples 105, a respective action sequence similarity score 125. The action sequence similarity score 125 measures a similarity between the initial action sequence from the initial plan 115 and a respective action sequence included in the respective example plan of the candidate task-plan example. In this context, a “similarity” can refer to the degree of structural and procedural correspondence between two sequences of actions, rather than semantic similarity between task descriptions. For example, two plans can be considered similar if they share a significant, ordered subsequence of actions, even if the specific objects being manipulated are different. For example, for a robotic manipulation task, an action sequence like (unstack b1 b2), (put-down b1), (pick-up b3), (stack b3 b4) can be considered similar to (unstack b5 b6), (put-down b5), (pick-up b7), (stack b7 b8) because the fundamental procedure of unstacking an object to free another is preserved.

In one implementation, the action sequence similarity can be quantified by identifying the longest common subsequence (LCAS) of actions between two sequences and normalizing the result, for example, using the geometric mean of the sequence lengths. In some cases, the similarity score 125 is computed by determining the longest common subsequence between the initial action sequence and a candidate action sequence, and then calculating a ratio of that subsequence length to the lengths of the two sequences. In another implementation, an edit distance metric can be used to compute the similarity. This metric calculates the minimum number of single-action edits (i.e., insertions, deletions, or substitutions) required to change one action sequence into the other. A lower edit distance signifies a higher degree of similarity, and the resulting distance value can be normalized to produce a similarity score. To improve efficiency, similarity scores for multiple candidate examples can be computed in parallel.

The computed action sequence similarity scores 125 are then provided to an example selection engine 130. The example selection engine 130 uses the action sequence similarity scores 125 to select a set of task-plan examples 135 from the plurality of candidate task-plan examples 105. For instance, the engine can select task-plan examples 135 by prioritizing those with the highest similarity to the initial plan 115.

In some implementations, the selection process can be implemented as a multi-stage methodology designed to balance the relevance and diversity of the selected examples. In a first stage focused on relevance, the example selection engine 130 can perform a threshold-based selection. This involves selecting a first subset of candidate examples with similarity scores 125 above a first threshold, thereby including exemplars that share a strong procedural similarity with the initial plan 115. The first threshold can be determined dynamically by analyzing the statistical distribution of all similarity scores 125. For example, the engine 130 can compute the mean and standard deviation of the scores and set the threshold based on these parameters (e.g., mean plus a multiple of the standard deviation), allowing the relevance criteria to adapt to the specific context of the input task and the candidate pool.

In a second stage focused on diversity, the above relevance-based filtering can be augmented with a clustering-based sampling process. This stage can operate on a second subset of examples with scores in a moderate range, for instance, between the first threshold score and a lower, second threshold score. The example selection engine 130 performs a clustering operation on this subset, grouping the candidate examples into clusters based on their pairwise action sequence similarities with each other. To reduce redundancy, the engine 130 then selects one or more examples from each resulting cluster, sometimes capping the number chosen per cluster to balance diversity and relevance. This combined approach ensures that the final selected set of task-plan examples 135 contains not only the most relevant exemplars but also a diverse range of examples that can expose the generative machine learning model 150 to a broader set of solution strategies.

After the examples 135 have been selected, the system 100 processes, using the generative machine learning model 150, (i) the query 110 and (ii) one or more prompt inputs generated using the selected set of task-plan examples 135, to generate an output plan 160. In some implementations, the output plan 160 can be stored in a plan repository for later retrieval, analysis, or reuse. In some cases, the system can parse the plan into a structured data format and perform a validity check to ensure the plan is executable and satisfies the task goals. In some implementations, a valid output plan can be stored and added to the candidate task-plan examples 105, allowing it to be used as a high-quality exemplar for future tasks. The system can also provide the plan for execution, for instance, by transmitting it to a downstream control system or by displaying it to a human user for review or manual implementation.

In some implementations, the generative machine learning model 150 generates the output plan 160 through a prompting strategy. In this approach, the selected set of task-plan examples 135 is formatted into a prompt that is provided as input to the model 150 along with the query 110. The model 150, which can be a pre-trained language model such as a large language model (LLM), processes this combined input to generate the output plan 160. During this prompting process, the internal parameters, such as neural network weights, of the generative machine learning model 150 can remain unchanged. By leveraging its pre-trained capabilities, the model 150 infers the underlying structure and logic from the provided task-plan examples to generate a novel plan for the input task, without requiring modification of its internal parameters.

In some implementations, a fine-tuning strategy can be employed to adapt the generative machine learning model 150 for the specific task of plan generation. Generally, the generative machine learning model 150 is a generative neural network that has been trained across one or more training stages. For example, the training can include a pre-training stage in which the neural network is trained on a next-token prediction task, i.e., predicting a subsequent token in a sequence given the preceding tokens. In some cases, the model can be pre-trained on a maximum-likelihood objective using a large dataset of text in one or more natural languages, a large dataset of computer code in one or more programming languages, audio data, images, video data, or a multimodal dataset that includes combinations of these modalities. A pre-trained version of the model can be obtained from such training in any convenient manner, for example, using a softmax cross-entropy loss with teacher forcing, an autoregressive negative log-likelihood loss, or a masking loss that requires the model to predict missing text or image tokens.

In addition to pre-training, the one or more training stages can also include one or more fine-tuning stages, which may comprise supervised fine-tuning, reinforcement learning, preference learning, instruction tuning, or other post-training procedures. For the task of plan generation, fine-tuning can be performed on a dataset of task-plan examples, where each training example includes data specifying an input task and a corresponding target plan with a target action sequence. For each such training example, the model can be used to generate an output plan for the input task. A loss function can be computed based on a comparison between the generated output plan and the target plan. For instance, an action sequence similarity score can be computed that measures a similarity between an output action sequence in the generated plan and the target action sequence in the target plan. The values of the parameters of the generative machine learning model 150 can then be updated using this computed score, for example, through backpropagation and gradient descent, to improve the model’s ability to generate accurate and logically coherent plans. Once this finetuning process is complete, the resulting fine-tuned model can be used to generate the output plan 160 for a given query 110.

The output plan 160 can take various forms depending on the input task and its specific domain. The following examples illustrate several applications:

For a travel planning task, the query 110 may request an itinerary for a multi-city trip. The resulting output plan 160 can include a structured sequence of actions that specify the order of destinations and durations, creating a complete travel schedule that a user or an automated booking agent can execute.

In a robotic manipulation environment, such as moving or assembling one or more objects, the input task 110 might specify an initial and a desired goal configuration of objects. The generated output plan 160 can include a sequence of a sequence of commands for a robotic agent, such as a robotic arm. This plan can be provided to a robot control system, which translates the actions into control signals for execution.

For a software development task, the query 110 can describe a programming problem or a bug report, and the output plan 160 can be a sequence of logic steps or code snippets. This plan can serve as a high-level guide or a complete code solution for a developer.

For a web navigation task, the input task 110 can be a request to extract specific information. The output plan 160 would specify a sequence of browser actions. This sequence can be executed by a web automation script to perform the task automatically.

In some implementations, an iterative process can be employed. The generated output plan 160 from a preceding iteration can be used as the initial plan 115 for the current iteration. The system can then compute updated action sequence similarity scores using the action sequence from this output plan 160 to select an updated set of task-plan examples, which are then used by the model 150 to generate a refined output plan for the current iteration. This iterative refinement can continue for a plurality of iterations to progressively improve the quality of the final plan. The number of iterations can be a predetermined fixed value or be determined dynamically based on one or more stopping criteria. For example, the system can terminate the process based on plan validity, stopping the iterations once a plan validator determines that the generated output plan 160 is valid and successfully achieves the goals of the input task. In another example, a convergence criterion can be used to end the process when the quality of the output plan 160 stabilizes, which can be determined by comparing plans from successive iterations and stopping when they are identical or when a quality metric exceeds a defined threshold. The iterations can also be constrained by a resource-based limit, such as a maximum computation budget or a time constraint, to ensure efficient operation.

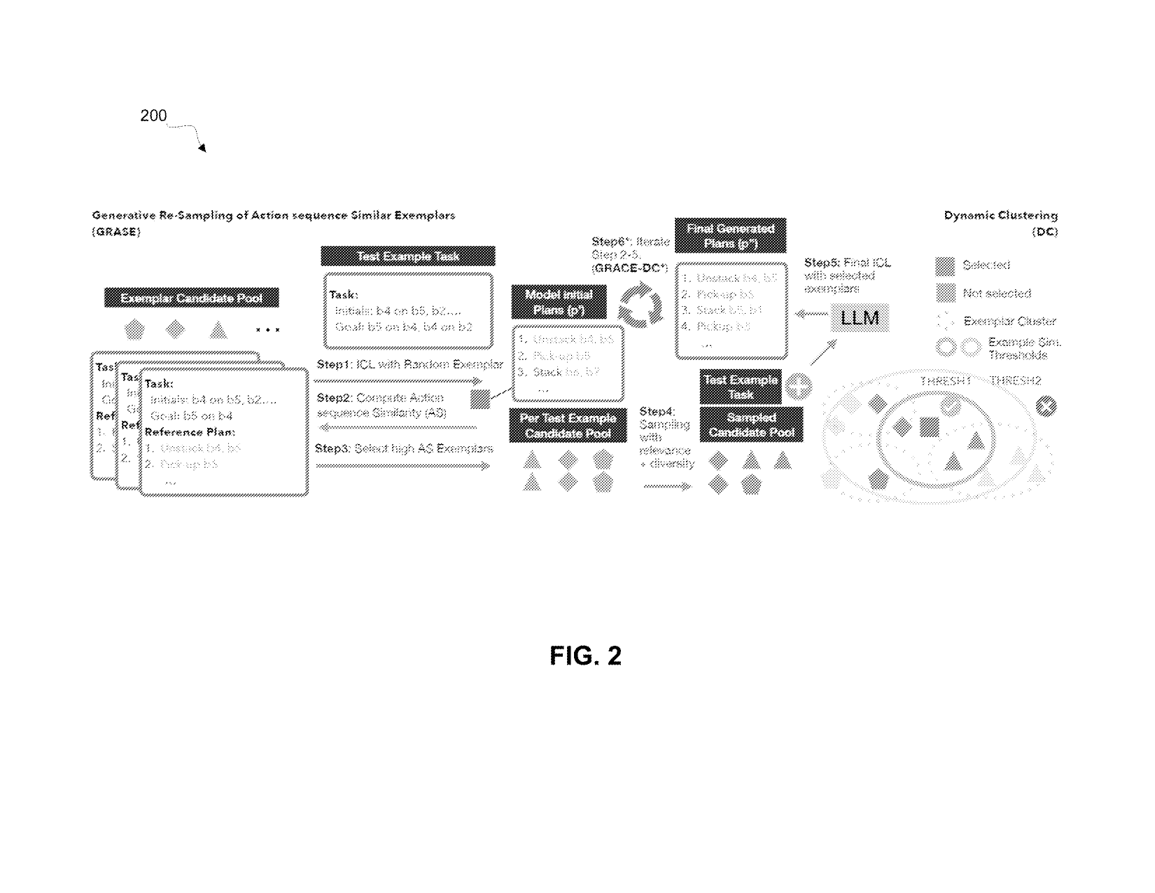

FIG. 2 illustrates an example of a process 200 for selecting task-plan examples, which can be performed by the example selection engine 130 of FIG. 1. The process 200 refines a large candidate pool of task-plan examples into a smaller, curated set of examples that are both highly relevant to an input task (e.g., query 110) and diverse in their solution strategies. The process 200 can be conceptually divided into a first stage that applies relevance-based filtering and a second stage that improves diversity through clustering.

In the first stage, the system can begin at Step 1 by prompting the generative machine learning model 150 with the input task and a few randomly selected candidate examples. This produces one or more initial plans (p’), which serve as provisional solutions.

At Step 2, the action sequence from an initial plan (p’) is extracted and used by the similarity scoring engine 120 to compute action sequence similarity scores against the action sequences of all examples in the candidate pool. This scoring process identifies examples that exhibit similar procedural structures.

At Step 3, the candidate examples are ranked according to their similarity scores, and those with high scores are selected. This creates an intermediate candidate pool that is smaller and more relevant than the original pool.

In the second stage, shown at Step 4, the intermediate pool is further refined through a relevance-and-diversity sampling process. Candidate examples are grouped into clusters based on their action sequence similarities with one another. A threshold can be applied to include highly relevant examples, while additional examples are sampled from the remaining clusters to ensure diversity. In some implementations, a limit can be applied to the number of examples selected from each cluster to reduce redundancy. The result is a curated set of task-plan examples 135 that balances both relevance and diversity.

At Step 5, the curated set of task-plan examples 135 is combined with the input task and used to prompt the generative machine learning model 150. This produces a refined output plan (p*), which can represent an improved plan compared to the initial plan (p’).

The diagram also illustrates an optional iterative loop at Step 6. In this iterative refinement, the refined output plan (p*) from one iteration can be used as the basis for a subsequent iteration of the process, beginning for example at Step 2. This allows the system to progressively improve the quality of the generated plan through repeated refinement of exemplar selection.

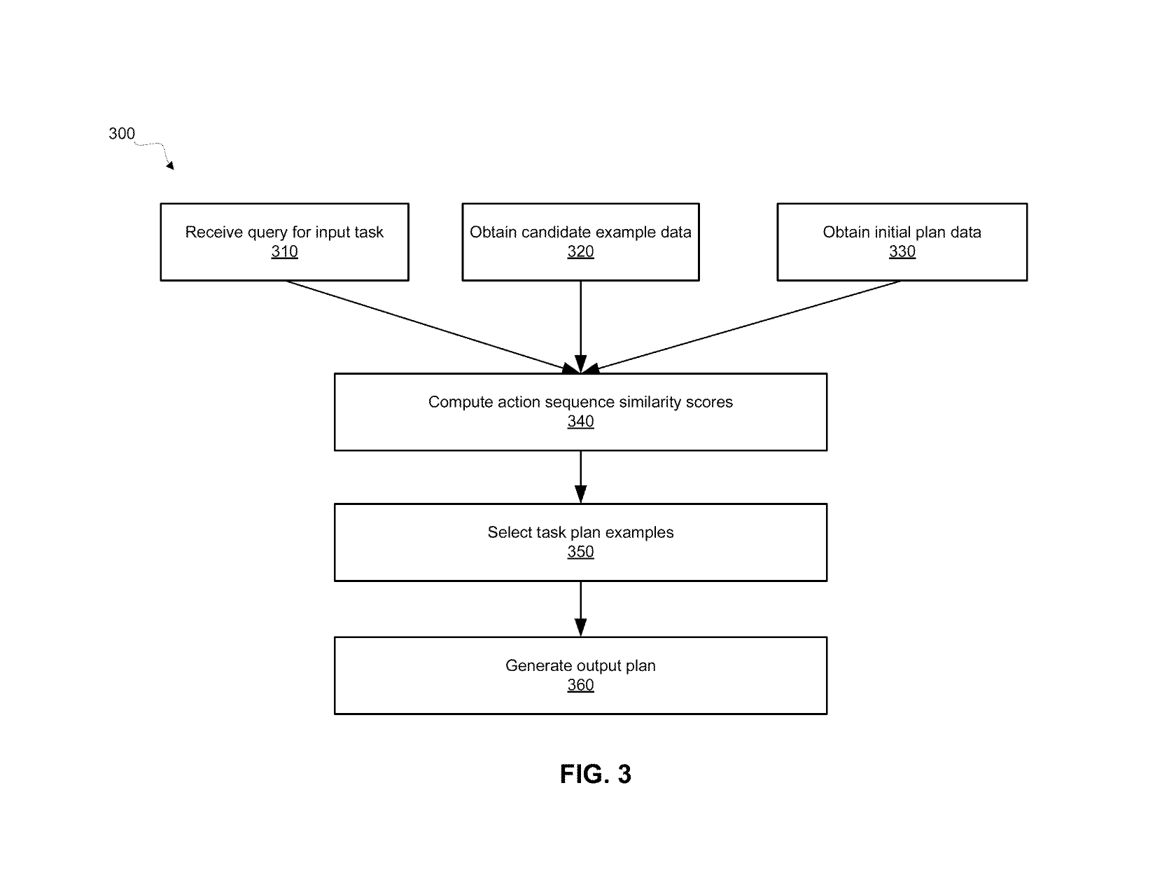

FIG. 3 is a flow diagram of an example process 300 for generating a response to a query using a generative machine learning model. For convenience, the process 300 will be described as being performed by a system of one or more computers located in one or more locations. For example, a computer-implemented system, e.g., the system 100 depicted in FIG. 1, appropriately programmed in accordance with this specification, can perform the process 300.

At 310, the system receives a query for an input task. The query includes a request to generate a plan for the task. In some implementations, the query can include a text sequence, such as a natural language description or structured text in a format like Planning Domain Definition Language (PDDL). In other implementations, the query can include one or more of an image, a video, an audio, or sensor data, which can provide multimodal context for the task. The input task itself can relate to a wide range of domains. In some implementations, the input task can specify a task in a real-world environment, and the output plan specifies actions or routes to be taken in the real-world environment. This can include, for example, a physical task to be completed by one or more robotic agents, where the output plan includes a sequence of actions for the robotic agents. In another example, the input task can specify navigating a vehicle to a destination, with the output plan including a sequence of navigational instructions. In a further example, the task can specify diagnosing a fault of a system operating in the real-world environment, where the output plan specifies a sequence of measurements to be made.

At 320, the system obtains candidate example data. This data defines a plurality of candidate task-plan examples, for instance, from a existing example pool or database. Each candidate task-plan example includes a respective example task and a corresponding respective example plan. The respective example plan can provide a valid sequence of actions to accomplish the respective example task.

At 330, the system obtains data defining an initial plan for the input task received at 310. This initial plan includes an initial action sequence, which is a sequence of a plurality of actions. In some implementations, obtaining the data for the initial plan includes generating it using the generative machine learning model. This can be accomplished by selecting an initial set of task-plan examples from the candidate examples obtained at 320. In some implementations, the initial set is randomly selected. The system can then process, using the generative machine learning model, the query from 310 and one or more prompt inputs generated using this selected initial set to generate the initial plan.

In some implementations, the system can determine a validity of the initial plan before further proceeding. This can include checking if the initial plan satisfies one or more conditions, such as whether each action complies with a predefined set of rules, whether sequential dependencies between actions comply with a predefined set of rules, or whether the sequence achieves the task’s goals according to a predefined set of rules. If the initial plan is determined to be invalid, in some implementations, the system can generate a revised initial plan, for example, by selecting a new initial set of task-plan examples and repeating the generation process.

At 340, the system computes action sequence similarity scores. For each of the plurality of candidate task-plan examples obtained at 320, the system computes a respective action sequence similarity score. This score measures a similarity between the initial action sequence from the initial plan (from 330) and a respective action sequence included in the respective example plan of the candidate task-plan example. In some implementations, computing the score includes identifying a longest common subsequence of actions between the initial action sequence and the respective action sequence, and then computing the score based on a ratio of the length of this longest common subsequence relative to the lengths of the initial and respective action sequences. To facilitate efficiency, in some implementations, the system can compute two or more of the similarity scores in parallel.

At 350, the system selects a set of task-plan examples from the candidate pool using the action sequence similarity scores computed at 340. In some implementations, this selection process involves multiple stages to balance relevance and diversity of the selected set. For example, the system can select a first subset of candidate task-plan examples with respective scores that are above a first threshold score. This first threshold score can be determined dynamically, for instance, by obtaining distribution data of the scores and setting the threshold based on a mean and standard deviation of the distribution. The system can then select a second subset of examples with scores between the first threshold and a lower second threshold. To further enhance diversity, a third subset can be selected from this second subset. In some implementations, selecting this third subset involves performing a clustering operation on the second subset to group examples based on their pairwise action sequence similarities. The system can then select one or more candidate examples from each resulting cluster, and in some cases, select no more than a threshold number of examples from each cluster. The first subset and the third subset can then be included in the final selected set of task-plan examples.

At 360, the system generates an output plan. The system processes, using a generative machine learning model, (i) the query from 310 and (ii) one or more prompt inputs generated using the selected set of task-plan examples from 350. The generative machine learning model can be, for example, a neural network including one or more attention layers.

In some implementations, the parameters of the generative machine learning model can remain unchanged during this generation process. The resulting output plan can be a refined, higher-quality plan for the input task as a result of leveraging one or more prompt inputs including the selected set of task-plan examples.

In other implementations, the system can use a fine-tuning strategy to adapt the generative machine learning model for generating plans. The generative machine learning model can be a pre-trained model that is subsequently trained further on a specialized dataset. This process can involve obtaining one or more training examples, where each training example includes data specifying an input task and a corresponding target plan, which includes a target action sequence. For each of these training examples, the system can use the generative machine learning model to generate an output plan for the input task specified in the training example. The system can then compute a loss function based on a comparison between this generated output plan and the target plan. For instance, this comparison can involve computing an action sequence similarity score that measures the similarity between an output action sequence in the generated plan and the target action sequence in the target plan. The values of the parameters of the generative machine learning model can then be updated using this computed score, for instance, through one or more iterations of backpropagation and gradient descent. This fine-tuning process adjusts the model’s internal parameters to improve its capability to generate accurate and logically coherent plans for the specific domain of the training data. The fine-tuned model can then be used to generate the final output plan for the query.

In some implementations, the system can provide this plan for execution, for instance, by providing the plan to a computer-implemented control system to cause it to generate one or more control signals. Furthermore, the process 300 can be performed iteratively. In such implementations, the output plan generated in one iteration can be used as the initial plan in a subsequent iteration, with the process resuming from operation 340 to compute updated similarity scores and select a new set of examples to further refine the plan over a plurality of iterations.

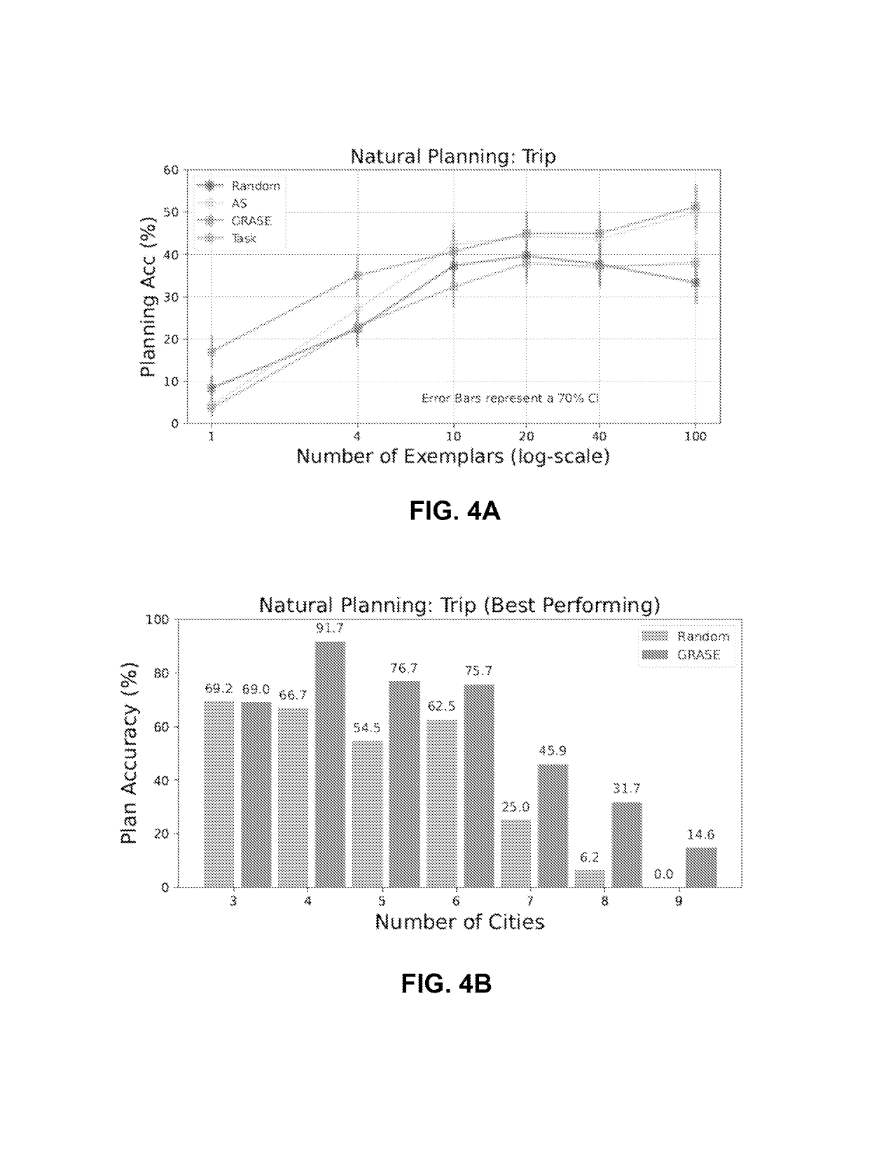

FIG. 4A and 4B illustrate performance comparison between the described techniques with baseline techniques on a natural language trip planning task. The performance is measured by “Planning Accuracy (%)”, which represents the percentage of test examples for which a valid and correct plan was generated.

FIG. 4A illustrates the relationship between planning accuracy and the number of exemplars provided to the generative model, with the number of exemplars shown on a logarithmic scale. The plot compares four different exemplar selection methods: a “Random” selection baseline, a “Task” similarity baseline that selects exemplars based on task description similarity, an “AS” (Action Sequence) similarity baseline that uses oracle plans, and the “GRASE” method, which uses model-generated initial plans to compute action sequence similarity. The results indicate that the GRASE method consistently achieves higher planning accuracy than the Random and AS methods across different numbers of exemplars. The Task similarity method performs similarly to or slightly better than GRASE at very low exemplar counts but is surpassed by GRASE as the number of exemplars increases. This suggests that leveraging action sequence similarity from a model-generated initial plan is a more effective strategy for selecting relevant exemplars than relying on random selection or task description similarity, particularly when a larger context of examples is used.

FIG. 4B provides a performance comparison between the Random baseline and the GRASE method, broken down by problem complexity, which is represented by the “Number of Cities” in the trip planning task. The chart shows the best-performing plan accuracy for both methods. For tasks with a small number of cities (e.g., 3), the performance of both methods is comparable. However, as the number of cities increases, indicating a more complex planning problem, the performance of the Random baseline degrades significantly, dropping to zero for nine cities. In contrast, the GRASE method consistently outperforms the Random baseline, maintaining a considerable level of accuracy even for the most complex tasks shown. This demonstrates that the described technique is particularly advantageous for solving harder planning problems where random or less-informed exemplar selection methods may fail.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method, comprising:
receiving a query comprising a request to generate a plan for an input task;
obtaining candidate example data defining a plurality of candidate task-plan examples, wherein each candidate task-plan example comprises (i) a respective example task and (ii) a respective example plan for achieving the respective example task;
obtaining data defining an initial plan for the input task, wherein the initial plan comprises an initial action sequence that includes a sequence of a plurality of actions;
computing, for each of the plurality of candidate task-plan examples, a respective action sequence similarity score measuring a similarity between (i) the initial action sequence and (ii) a respective action sequence included in the respective example plan in the candidate task-plan examples;
selecting, using the action sequence similarity scores, a set of task-plan examples from the plurality of candidate task-plan examples; and
processing, using a generative machine learning model, (i) the query and (ii) one or more prompt inputs generated using the selected set of task-plan examples, to generate an output plan.

2. The method of claim 1, wherein obtaining the data defining the initial plan for the input task comprises:
selecting an initial set of task-plan examples from the candidate task-plan examples; and
processing, using the generative machine learning model, (i) the query and (ii) one or more prompt inputs generated using the selected initial set of task-plan examples to generate the initial plan.

3. The method of claim 2, wherein the initial set of task-plan examples is randomly selected from the candidate task-plan examples.

4. The method of claim 2, further comprising:
determining a validity of the initial plan for the input task; and
in response to determining that the initial plan is invalid, generating a revised initial plan.

5. The method of claim 4, wherein generating the revised initial plan comprises:
selecting a new initial set of task-plan examples from the candidate task-plan examples;
and
generating the revised initial plan for the input task using the new initial set of task-plan examples from the candidate task-plan examples.

6. The method of claim 2, wherein obtaining the data defining the initial plan for the input task comprises selecting the initial set of task-plan examples at each of a plurality of iterations, wherein selecting the initial set of task-plan examples comprises, at each iteration after the first iteration:
computing updated action sequence similarity scores between (i) an action sequence included in the output plan generated by the generative machine learning model in a preceding iteration and (ii) the respective action sequences included the respective example plans in the candidate task-plan examples;
selecting, using the updated action sequence similarity scores, an updated set of task-plan examples from the plurality of candidate task-plan examples; and
processing, using the generative machine learning model, (i) the query and (ii) one or more prompt inputs generated using the updated set of task-plan examples, to generate the output plan for the iteration.

7. The method of claim 1, wherein selecting, using the action sequence similarity scores, the set of task-plan examples from the plurality of candidate task-plan examples comprises:
selecting a first subset of candidate task-plan examples with respective action sequence similarity scores above a first threshold score; and
including the first subset of candidate task-plan examples in the selected set of task-plan examples.

8. The method of claim 7, wherein determining the first threshold score comprises:
obtaining distribution data characterizing a distribution of the respective action sequence similarity scores of the set of candidate task-plan examples; and
determining the first threshold score based on the distribution data.

9. The method of claim 8, wherein determining the first threshold score comprises:
obtaining a mean value and a standard deviation value of the distribution; and
determining the first threshold score based on the mean value and the standard deviation value.

10. The method of claim 7, wherein selecting, using the action sequence similarity scores, the set of task-plan examples from the plurality of candidate task-plan examples further comprises:
selecting a second subset of candidate task-plan examples with respective action sequence similarity scores between the first threshold score and a second threshold score, wherein the second threshold score is below the first threshold score;
selecting a third subset of candidate task-plan examples from the second subset of candidate task-plan examples; and
including the third subset of candidate task-plan examples in the selected set of task-plan examples.

11. The method of claim 10, wherein selecting the third subset of candidate task-plan examples comprises:
performing a clustering operation on the second subset of candidate task-plan examples to group the candidate task-plan examples into clusters based on action sequence similarity scores computed for action sequences of each pair of the candidate task-plan examples in the second subset; and
selecting one or more candidate task-plan examples from each cluster.

12. The method of claim 11, wherein selecting one or more candidate task-plan examples from each cluster comprises:
selecting no more than a threshold number of candidate task-plan examples from each cluster.

13. The method of claim 1, wherein computing the respective action sequence similarity score between (i) the initial action sequence and (ii) the respective action sequence corresponding to the respective example plan comprises:
identifying a longest common subsequence of actions between the initial action sequence and the respective action sequence; and
computing the action sequence similarity score based on a ratio of the length of the longest common subsequence relative to the lengths of the initial action sequence and the respective action sequences.

14. The method of claim 1, wherein the generative machine learning model comprises a neural network comprising one or more attention layers.

15. The method of claim 1, wherein parameters of the generative machine learning model remain unchanged during generating the plan for the input task.

16. The method of claim 1, wherein the input task specifies a task in a real-world environment, and the output plan specifies actions or routes to be taken in the real-world environment.

17. The method of claim 1, further comprising:
providing the plan to a computer-implemented control system to cause the computer-implemented control system to generate one or more control signals for executing the plan.

18. The method of claim 1, wherein the query comprises one or more of: a text sequence, an image, a video, an audio, or sensor data.

19. A system comprising:
one or more computers; and
one or more storage devices storing instructions that when executed by the one or more computers, cause the one or more computers to perform the operations comprising:
receiving a query comprising a request to generate a plan for an input task;
obtaining candidate example data defining a plurality of candidate task-plan examples, wherein each candidate task-plan example comprises (i) a respective example task and (ii) a respective example plan for achieving the respective example task;
obtaining data defining an initial plan for the input task, wherein the initial plan comprises an initial action sequence that includes a sequence of a plurality of actions;
computing, for each of the plurality of candidate task-plan examples, a respective action sequence similarity score measuring a similarity between (i) the initial action sequence and (ii) a respective action sequence included in the respective example plan in the candidate task-plan examples;
selecting, using the action sequence similarity scores, a set of task-plan examples from the plurality of candidate task-plan examples; and
processing, using a generative machine learning model, (i) the query and (ii) one or more prompt inputs generated using the selected set of task-plan examples, to generate an output plan.

20. One or more computer-readable storage media storing instructions that, when executed by one or more computers, cause the one or more computers to perform the operations of comprising:
receiving a query comprising a request to generate a plan for an input task;
obtaining candidate example data defining a plurality of candidate task-plan examples, wherein each candidate task-plan example comprises (i) a respective example task and (ii) a respective example plan for achieving the respective example task;
obtaining data defining an initial plan for the input task, wherein the initial plan comprises an initial action sequence that includes a sequence of a plurality of actions;
computing, for each of the plurality of candidate task-plan examples, a respective action sequence similarity score measuring a similarity between (i) the initial action sequence and (ii) a respective action sequence included in the respective example plan in the candidate task-plan examples;
selecting, using the action sequence similarity scores, a set of task-plan examples from the plurality of candidate task-plan examples; and
processing, using a generative machine learning model, (i) the query and (ii) one or more prompt inputs generated using the selected set of task-plan examples, to generate an output plan.
